(19) United States
(12) Patent Application Publication
(10) Pub. No.: US 2007/0001865 A1
(43) Pub. Date: Jan. 4, 2007

(54) Smoke detector

(76) Inventor: Philip Rowe, Hobe Sound, FL (US)

Correspondence Address: RALPH D CHABOT, 2310 E PONDEROSA DR, SUITE 4, CAMARILLO, CA, 93010, US

(21) Appl. No.: 10/877,030

(22) Filed: Jun. 24, 2004

Related U.S. Application Data
(60) Provisional application No. 60/480,788, filed on Jun. 24, 2003.

(51) Int. Cl. G08B 17/10

(52) U.S. Cl. 340/628

(57) ABSTRACT

A smoke/fire detection system for the detection of smoke or fire produced by a malfunctioning pipe heating tape or other electrical devices. The detector automatically shuts off the power to the affected tape or device and provides an alarm indicating the malfunction and its location to enable repairs to be made. In a preferred embodiment, the detection system includes a computer and a fire extinguisher. The computer determines if a fire is present at a selected location and turns on the fire extinguisher automatically when fire is present.

### BACKGROUND

1. FIELD

The present invention relates to smoke detectors and more particularly to the employments of smoke detectors placed in remote locations.

2. PRIOR ART

The following are summaries of patents related to smoke detectors and the automatic shut down of power in response to the detection of smoke.

U.S. Pat. No. 3,952,294 illustrates an emergency smoke alarm system for transmitting an alarm from a remote location. However, it fails to have a means for cutting off power to a heating element such as a heat tape.

U.S. Pat. No. 4,038,649 illustrates a smoke detector with a unijunction transistor which, when a preselected threshold has been exceeded, activates a horn. However, it fails to have a circuit which would specifically cut off a power line to deactivated a heat tape.

U.S. Pat. No. 4,194,192 illustrates an alarm system that is triggered by multiple sensors which can include a smoke detector. However, it fails to have a specific circuit to deactivate a power line.

U.S. Pat. No. 4,694,285 illustrates a combination light socket and smoke/heat detector. However, it fails to have a specific circuit to deactivate a power line.

U.S. Pat. No. 4,763,115 illustrates a smoke detector activates light/alarm systems to direct people to an exit in the event of a fire. However, it fails to have a specific circuit to deactivate a power line.

Commercial GEZE smoke switch control unit RSZ5 is a switch giving a closed contact on activation rather than an open circuit.

For the most part, the prior art devices provide alarm circuits to indicate that smoke has been detected, but none of the above mentioned devices are designed to shut down the power to heating elements, nor are they adapted to, in addition, provide a remote alarm. These and other short comings of the prior art are overcome in the present invention which is described below.

### BRIEF DESCRIPTION OF THE DRAWINGS

FIG. 1 is a diagram of a smoke detector connected to deactivate power to a heating tape when smoke is detected.

FIG. 2 is a block diagram of a smoke detector with a gathering fan and horn to detect smoke over either a wide or narrow area and to remotely indicate the status of the detector.

FIG. 3 is a block diagram of a smoke detector with a light filter for testing the smoke detector's operating status.

FIG. 4 shows a remote alarm status panel for multiple smoke detectors.

FIG. 5 shows a remote control panel for multiple smoke detectors.

FIG. 6 is a perspective drawing of a smoke detector with a built in plug and socket.

FIG. 7 a perspective drawing of a smoke detector with a line cord and a socket.

FIG. 8 is a block diagram of a smoke detector combined with a fire extinguisher which is activated to extinguish a detected fire.

FIG. 9 is a block diagram of four senses which feed a computer used to determine if fire is present at a selected site.

### SUMMARY

It is an object of the present invention to provide a means for automatically shutting off the power to malfunctioning heating tapes to aid in preventing fires.

It is an object of the present invention to provide a remote alarm to indicate where a malfunction tape is located.

It is an object of the present invention to provide a test station to enable the performance of the smoke detector to be monitored from a remote location.

It is an object of the present invention to provide a means by which one smoke detector can monitor multiple heating tapes.

The present invention is a smoke/fire detector for the detection of smoke or fire produced by malfunctioning heating elements such as pipe heating tapes or other electrical devices. The detector automatically shuts off the power to the affected device or tape and provides an alarm indicating the specifics smoke detector involved and the area in which the malfunction tape is located to enable repairs to be made.

In one embodiment of the present invention, a fan or a horn, or both, are attached to the smoke detector. The fan draws in the air over a wide area to determine if smoke is being produced by any one of multiple tapes in that area. The horn is used to shield the detector from extraneous light sources and direct the detector to smoke/fire that is occurring in a relatively narrow area.

In a preferred embodiment, the detector is a system which includes a computer and a fire extinguisher. The computer determines if a fire is present at a selected location and turns on the fire extinguisher automatically when fire is present.

### DETAILED DESCRIPTION OF THE INVENTION

FIG. 1 is a diagram of a smoke detector connected to a switch that controls the power that is being delivered to the heating tape. The smoke detector causes the switch to open when smoke is detected. This diagram includes a heating tape 1A wrapped about a pipe 1B. Such heating tapes contain heating elements and are used to prevent pipes from freezing in winter. Power is supplied to the heating tape by way of an input power line 4 which passes through a switch 2 to a second power line 5 that is connected to the tape. A smoke detector 3 is connected to open the switch when smoke is detected. In the operation of the system shown in FIG. 1, if the heating tape 1A starts to produce smoke due to a malfunction, such as a short circuit, the smoke is detected by the smoke detector 3. The smoke detector transmits a signal to the switch 2, causing it to open and disconnect the power from the heating tape 1A. The basic detection system shown in FIG. 1 helps to provide safe operation of the heating tapes or other electrical devices by preventing fires which would ordinarily occur if this system were not employed.

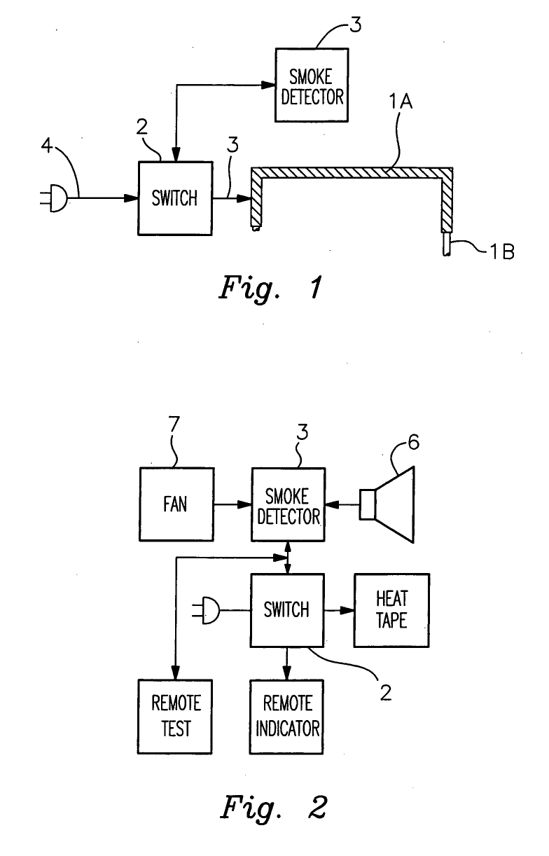

It is possible to enhance the system of FIG. 1 by adding a number of components as shown in FIG. 2. FIG. 2 is a block diagram of a smoke detector system with a gathering fan and horn to detect smoke over a wide or narrow area respectively and to remotely indicate the status of the detector. In FIG. 2, a gathering fan 7 is connected to the smoke detector 3 to draw air from a wide area and pass the air through the smoke detector. The large volume of air being passed through the smoke detector allows it to detect smoke over a wide area. However, there is a problem with using a fan in this manner. Since a larger amount of air will be passing through the smoke detector when the fan is used, the sensitivity of the smoke detector must be raised accordingly to allow it to detect smaller amounts of smoke in the air and still cause the smoke detector to generate an alarm.

When using a smoke detector that operates by passing light through the air to determine the smoke content, care must be exercised to avoid extraneous light sources which can cause the smoke detector to malfunction. In such cases, it is possible to attach a horn, such as horn 6 to shade the detector from the extraneous light. One side effect of the use of the horn is causing the smoke detector to cover a narrow area. In this respect, the horn has the opposite effect of the fan. The horn can be directed at a particular area and restrict the flow of air passing the detector to that reduced area. Each application requires its own particular system configuration which may include either the fan or the horn.

A horn can also be used with an IR or smoke detector with the horn directed at the device to be protected. This prevents extraneous light from affecting the detector and thus improves the directivity of the detector.

Remote indication and control can be added to the system of FIG. 2. FIG. 4 shows a remote alarm status board 16 for multiple smoke detectors containing a series of indicator lights, such as indicator light 17. When a smoke detector has been activated, a line connecting the switch to the remote indicator panel 16 causes one of the indicator to be activated. At the remote location where the indicator panel is installed, it is possible to ascertain which smoke detector has been activated by the noting which indicator light has been activated. This is an important feature where the smoke detectors are located in areas where personnel are not normally located. With a remote indicator system, not only is the power shut off to the tape or other electrical devices, but personnel are alerted to the fact smoke/fire has been detected and they are advised where to go to rectify the problem before a pipe is damaged from failure to keep it heated.

FIG. 5 is a remote control panel 18 for multiple smoke or other detectors which includes a series of lights such as light 19 and an equal number of buttons such as button 20 located under each light. By pressing the button for a particular detector, the detector can be tested. The success or failure of the test is shown on the remote indicator panel 16.

Returning now to FIG. 2, the smoke detector is connected to the switch which shuts off the power to the heating tape when smoke is detected. In addition, when the switch opens, the remote indicator 10, which is connected to the switch, causes an indicator light to be lit to show that the switch has been opened. This is an important feature as heating tapes and the like are usually located in remote areas of a building, such as in a crawl space. If a fire were to start in such remote closed areas, the fire would be difficult to detect initially. The remote indicator panel overcomes this problem.

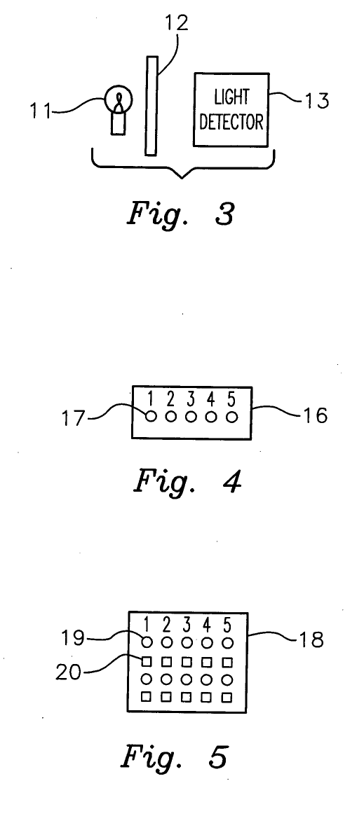

The remote test panel 9 is connected to the smoke detector and to the switch, enabling it to cause the switch to open on command. Whether or not the switch has opened can be checked by viewing the remote indicator panel 10. A further check can be carried out with panel 9. Smoke detectors often contain a light and a light detector. The presence of smoke is determined by the reduction of light received by the light detector. FIG. 3 is a block diagram of a smoke detector with an insertable filter to test both the light and the light detector in the smoke detectors. A second set of buttons and lights may be added to the test panel. Pressing one of these buttons on the remote panel activates a solenoid which causes the filter to be inserted in front of a light source 11 which is used to transmit light to the light detector 13. The filter reduces the light being transmitted in an amount similar to that which would occur if there were smoke in the air between the light and the light detector. This causes the light detector to produce an alarm which can be seen on the remote indicator 10. When the test is competed, the filter is removed by releasing the button on the test panel.

There is also another method of generating an alarm if there is a malfunction which may be used with the present invention. Returning to FIG. 2, the switch 2 may also contain a current detector 2A which senses the current on the power lines to determine if there has been a partial or a complete short between the wires in the heating tape or between the wires and the pipe about which it is wrapped. If the current imbalance on the lines indicates that there has been a partial or full short circuit, this causes the switch to open and to send a signal to the remote indicator 10. The use of a current detection can make it possible to eliminate the smoke detector as a necessary part of the system. Alternatively, both the smoke detector and the current detector may be kept to provide redundancy or the degree of urgency and the need for activating other devices such as a fire extinguisher.

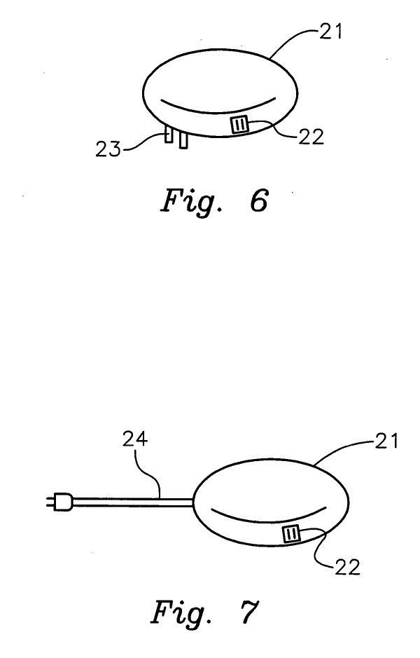

FIG. 6 shows a smoke detector 21 packaged in a pod shaped housing with a built in 110 volt plug 23 and receptacle 22. FIG. 7 is the same as FIG. 6 except it contains a line 24 cord with a plug in place of the plug 23. These units are useful in that the smoke detector and switch are built into a single housing that can be plugged into an outlet near the heating tape and provide a safe, switched outlet jack for the heating tape.

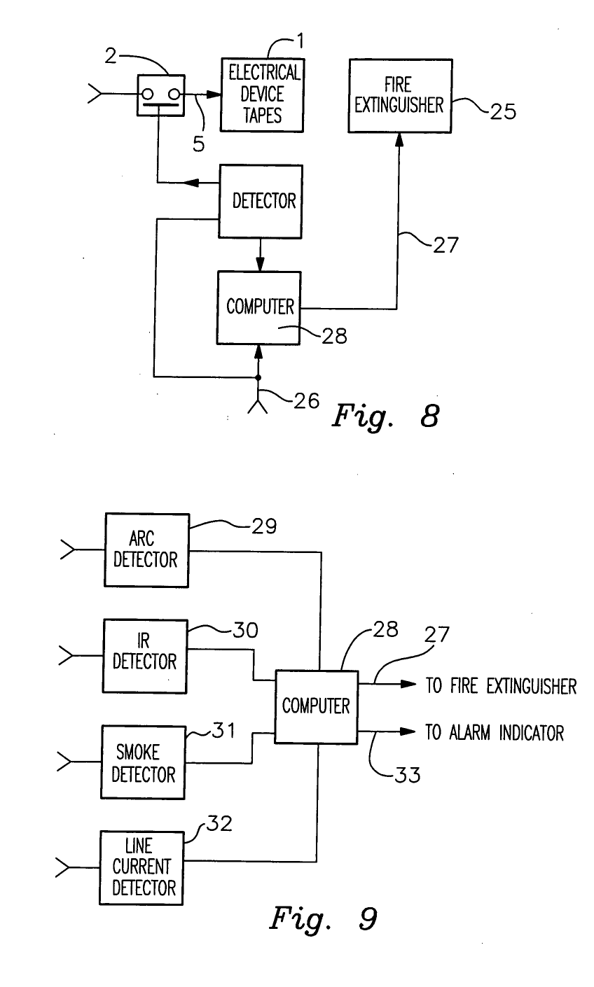

FIG. 8 is a smoke detection system which includes three additional features over and above the detectors described above. These features include a fire extinguisher 25, a computer 28 and a fire resistant power line 26. In this system, the fire extinguisher 25 is positioned close to and is directed at the tape. It is activated automatically when the detector determines a fire has started. The detector incorporates the computer 28 to determine from the inpots of detection if a fire has started. The power line 26 includes fire resistant installation to help insure operation of the detection system even if a fire has progressed to the point where it has affected some of the other power lines in the area. The protection system has this added measure of protection to insure its operation in a fire emergency. about which it is wrapped. If the current imbalance on the lines indicates that there has been a partial or full short circuit, this causes the switch to open and to send a signal to the remote indicator 10. The use of a current detection can make it possible to eliminate the smoke detector as a necessary part of the system. Alternatively, both the smoke detector and the current detector may be kept to provide redundancy or the degree of urgency and the need for activating other devices such as a fire extinguisher.

FIG. 6 shows a smoke detector 21 packaged in a pod shaped housing with a built in 110 volt plug 23 and receptacle 22. FIG. 7 is the same as FIG. 6 except it contains a line 24 cord with a plug in place of the plug 23. These units are useful in that the smoke detector and switch are built into a single housing that can be plugged into an outlet near the heating tape and provide a safe, switched outlet jack for the heating tape.

FIG. 8 is a smoke detection system which includes three additional features over and above the detectors described above. These features include a fire extinguisher 25, a computer 28 and a fire resistant power line 26. In this system, the fire extinguisher 25 is positioned close to and is directed at the tape or electrical device to be protected. It is activated automatically when the detector determines a fire has started. The detector incorporates the computer 28 to determine from the inputs of the detection if a fire has started. The power line 26 includes fire resistant installation to help insure operation of the detection system even if a fire has progressed to the point where it has affected some of the other power lines in the area. The protection system has this added measure of protection to insure its operation in a fire emergency.

FIG. 9 is a block diagram of four sensors which feed the computer 28 that is used to determine if a fire is present at a selected site. The purpose of this arrangement is to first automatically determine if a fire is in progress at a tape or other electrical device and then automatically activate a fire extinguisher to put out this fire. This arrangement overcomes the delay which normally occurs when an alarm is sounded and a person must respond. In some cases, there is no person immediate available to receive and respond to the alarm. This automatic system would still attend to extinguishing the fire.

The four sensors are an arc sensor, an IR sensor, a smoke detector, and a line current sensor. Other sensors may be added such as a simple temperature, if necessary, to make a more apt determination in a particular installation.

The arc sensor is used to detect arcs occurring in equipment. Arc produce high temperature which can easily cause fire. Arcs are detected by sensing a step in the normal sine wave input of the power supplied to a piece of equipment.

An IR detector is an infra-red detector which can detect high temperatures such as those caused by a fire. The higher the temperature of a fire, the higher the IR detector's output.

The smoke detector obviously detect smoke has been described above. It detects smoke which usually is present when there is a fire. It is one of the most common types of detectors used to detect the presence of fire.

The line current detector detects large current changes in the supply line to an electrical device to indicate possible short circuits which would be predicator of a possible fire.

The computer accepts all these inputs and compares them to preset standards which determine the presence of a fire or condition which could precipitate a fire. The following is a list showing an example prediction characteristics which may be used to produce a program for fire detection in a particular application. The characteristics may be changed to suit the application. The output of the computer may also be used to disconnect power to a device in question. The sensors may have dual functions in that they may feed the computer as described immediately above and also disrupt power as described earlier.

EXAMPLE OF DETECTOR SIGNAL LEVELS ALONE OR IN COMBINATIONS WHICH MAY BE USED TO INITIATE AN ALARM, AND INITIATION OF POWER SHUT OFF:

1. IR temperature indicator over 400° F. for 30 seconds.

2. IR temperature indicator over 200° F. and smoke detection level of 30% visibility for 30 seconds.

3. Smoke detector visibility level 10% for 30 seconds.

4. Arc detection for arcs estimated to produce temperatures over 400° F. for 30 seconds.

5. Line current detector indicates a 50% overload for 30 seconds.

As was done with the current and smoke detector, it is possible to test the IR and arc detector for the IR sensor. A light source with an appropriate color shield is inserted before the IR sensor. A specific output should be received to indicate satisfactory performance. For the arc sensor a signal with steps in the wave form simulating the presence of an arc is sent to the detector. A specific output is required to be received for satisfactory performance. All testing may be accomplished remotely at a test station with the results being indicated at that station.

Since it is possible to have smoke without flames and the flames of a fire without readily detectable smoke, and the invention described herein is intended to detect either or both, the term “smoke/fire” is used in the specification and in the claim to cover either or both situations and to also cover precursor to smoke and fire such as shorts and arcing which arc almost always result in smoke and fire.

Having described my invention, I claim:

1. A smoke/fire detection system for an electrical device having a power line to supply electrical power to said electrical device, comprising
(a) a detector to detect smoke/fire in said electrical device, said detector having an output port which emits a signal when smoke/fire is detected in said electrical device,
(b) a switch in said power line having an open and closed position, said open position shutting off said power supplied to said electrical device, said switch having an input port to receive a signal from said sensor to drive said switch to said open position, and
(c) means coupling said sensor output port and said switch input port to transmit to said switch the signal emitted from said sensor when smoke/fire is detected to place said switch in said open position and disconnect power to said devices in the event of smoke/fire in said device.

2. A system as claimed in claim 1, further comprising:
(a) an alarm means capable of actuated, said alarm means having an input port capable of receiving a signal from said detector output port to actuate said alarm means,
(b) means connecting said detector output port to said alarm input port to transmit said signal from said detector output port to said alarm input port to actuate said alarm upon the detection of smoke/fire by said detector.

3. A system as claimed in claim 2 further comprising:
(a) means for presenting a smoke/fire simulation to said detector to test activate said detector, said means for presenting having an input port to receive a test signal to cause simulation to occur, and
(b) means to remotely generate and transmit said test signal and transmitting said test signal to said means for presenting to actuate and test said detector's state of readiness.

4. A system as claimed in claim 1 wherein said detectors may include any detectors from the group which includes a smoke detector, an arc detector, an IR detector and a current detector.

5. A system as claimed in claim 4 wherein the system further comprises a fan set to draw smoke from said electrical device to said smoke detector to increase the directivity of said system.

6. A system as claimed in claim 4 wherein the detector is an IR detector and the detector further includes a horn directed at said electrical device to improve the directivity of said detector and shield the detector from extraneous light sources.

7. A system as claimed in claim 1 wherein said detector comprises a plurality of individual detectors each with an output port and each designed to sense a different characteristic of smoke/fire and each individual detector having an output port at which each emits a signal whose intensity is related to the intensity of the characteristic detected, said system further comprising:
(a) a computer with an output port and a plurality of input ports to accept the signals from said individual detectors, said computer including a program which determines from said computer input signals when a smoke/fire is present and in response to this determination produces an output signal at its out port,
(b) a fire extinguisher having an input port, said extinguisher being directed at said electrical device to extinguish smoke/fire in said electrical device when said extinguisher is activated by receiving at its input port said signal from said computer's output port, and
(c) means coupling said computer output port to said fire extinguisher input port to transmit said signal from said computer to said fire extinguisher to activate said fire extinguisher.

8. A system as claimed in claim 7 wherein said detectors include an arc detector, an IR detector, a smoke detector, and a current detector.

9. A system as claimed in claim 7 further comprising a horn directed at said electrical device to improve directivity of said IR detector and shield this detector from extraneous light sources.

10. A system as claimed in claim 8 further comprising a fan set to draw smoke from said electrical device to said smoke detector to increase the directivity of said system.
